(19) United States
(12) Patent Application Publication
(10) Pub. No.: US 2015/0131189 A1
(43) Pub. Date: May 14, 2015

(54) COMPOSITE HIGH VOLTAGE DC CIRCUIT BREAKER

(71) Applicants: Colin Charnock Davidson, Stafford (GB); Colin Donald Murray Oates, Brocton (GB); Alistair Burnett, Stafford (GB)

(72) Inventors: Colin Charnock Davidson, Stafford (GB); Colin Donald Murray Oates, Brocton (GB); Alistair Burnett, Stafford (GB)

(73) Assignee: ALSTOM TECHNOLOGY LTD, Baden (CH)

(21) Appl. No.: 14/381,570

(22) PCT Filed: Mar. 1, 2012
(86) PCT No.: PCT/EP2012/053573

§ 371 Date: Aug. 27, 2014

(51) Int. Cl. H02H 3/10; H02H 9/04; H02H 9/02

(52) U.S. Cl. CPC H02H 3/10; H02H 9/02; H02H 9/044
USPC 361/91.5

(57) ABSTRACT

A circuit breaker for high voltage direct current (HVDC) power transmission includes a module with a pair of terminals for connection to an electrical network, and four of conduction paths. Each first conduction path includes a mechanical switch connected in series with at least one first semiconductor switch to selectively allow current to flow between the first and second terminals through the first conduction path in a first mode of operation or commutate current from the first conduction path to the second conduction path in a second mode of operation. The second conduction path also has a semiconductor switch to selectively allow current to flow between the terminals through the second conduction path or commutate current from the second conduction path to the third conduction path in the second mode of operation. The third conduction path has a snubber circuit with an energy storage device to control a rate of change of voltage across the mechanical switch and oppose current flowing between the first and second terminals in the second mode of operation. The fourth conduction path has a resistive element to absorb and dissipate energy in the second mode of operation and divert charging current from the first and second terminals away from the energy storage device to limit a maximum voltage across the pair of terminals.

This invention relates to a circuit breaker apparatus for use in high voltage direct current (HVDC) power transmission.

In power transmission networks alternating current (AC) power is typically converted to direct current (DC) power for transmission via overhead lines and/or undersea cables. This conversion removes the need to compensate for the AC capacitive load effects imposed by the transmission line or cable, and thereby reduces the cost per kilometer of the lines and/or cables. Conversion from AC to DC thus becomes cost-effective when power needs to be transmitted over a long distance.

The conversion of AC to DC power is also utilized in power transmission networks where it is necessary to interconnect AC networks operating at different frequencies. In any such power transmission network, converters are required at each interface between AC and DC power to effect the required conversion.

HVDC converters are vulnerable to DC side faults or other abnormal operating conditions that can present a short circuit with low impedance across the DC power transmission lines or cables. Such faults can occur due to damage or breakdown of insulation, lightning strikes, movement of conductors or other accidental bridging between conductors by a foreign object.

The presence of low impedance across the DC power transmission lines or cables can be detrimental to a HVDC converter. Sometimes the inherent design of the converter means that it cannot limit current under such conditions, resulting in the development of a high fault current exceeding the current rating of the HVDC converter. Such a high fault current not only damages components of the HVDC converter, but also results in the HVDC converter being offline for a period of time. This results in increased cost of repair and maintenance of damaged electrical apparatus hardware, and inconvenience to end users relying on the working of the electrical apparatus. It is therefore important to be able to interrupt the high fault current as soon as it is detected.

A conventional means for protecting a HVDC converter from DC side faults, whereby the converter control cannot limit the fault current by any other means, is to trip an AC side circuit breaker, thus removing the supply of current that feeds the fault through the HVDC converter to the DC side. This is because there are currently no available HVDC circuit breaker designs. Furthermore, almost all HVDC schemes are currently point-to-point schemes with two HVDC converters connected to the DC side, whereby one HVDC converter acts as a power source with power rectification capability and the other HVDC converter acts as a power load with power inversion capability. Hence, tripping the AC side circuit breaker is acceptable because the presence of a fault in the point-to-point scheme requires interruption of power flow to allow the fault to be cleared.

A new class of mesh-connected HVDC power transmission networks are now being considered for moving large quantities of power over long distances, as required by geographically dispersed renewable forms of generation, and to augment existing capabilities of AC transmission networks with smartgrid intelligence and features that are able to support modern electricity trading requirements.

A mesh-connected HVDC power transmission network requires multi-terminal interconnection of HVDC converters, whereby power can be exchanged on the DC side using three or more HVDC converters operating in parallel. Each HVDC converter acts as either a source or sink to maintain the overall input-to-output power balance of the network whilst exchanging the power as required. Faults in the network need to be quickly isolated and segregated from the rest of the network, before an undesirable loss of power throughout the entire network occurs. In addition, fault currents from several converters that act as sources might merge to form a combined fault current, which, if not managed properly, would cause widespread damage to electrical equipment throughout the network.

Current interruption in conventional circuit breakers is carried out when the current reaches a current zero, so as to considerably reduce the difficulty of the interruption task. Thus, in conventional circuit breakers, there is a risk of damage to the current interruption apparatus if a current zero does not occur within a defined time period for interrupting the current. It is therefore inherently difficult to carry out DC current interruption because, unlike AC current in which current zeros naturally occur, DC current cannot naturally reach a current zero.

It is possible to carry out DC current interruption using a conventional AC circuit breaker by applying a forced current zero or artificially creating a current zero. One method of DC current interruption involves connecting an auxiliary circuit in parallel across the conventional AC circuit breaker, the auxiliary circuit comprising a capacitor or a combination of a capacitor and an inductor and being arranged to create an oscillatory current superimposed on the DC load current such that a current zero is created. Such an arrangement typically has a response time of tens of milliseconds, which does not meet the demands of HVDC grids that require a response time in the range of a few milliseconds.

EP 0 867 998 B1 discloses a conventional, solid-state DC circuit breaker comprising a stack of series-connected IGBTs in parallel with a metal-oxide surge arrester. This solution achieves the aforementioned response time but suffers from high steady-state power losses.

According to an aspect of the invention, there is provided a circuit breaker apparatus for use in high voltage direct current (HVDC) power transmission, the circuit breaker apparatus comprising one module or a plurality of series-connected modules;

the or each module including first, second, third and fourth conduction paths, and first and second terminals, each conduction path extending between the first and second terminals;

the first conduction path including a mechanical switching element connected in series with at least one first semiconductor switching element to selectively allow current to flow between the first and second terminals through the first conduction path in a first mode of operation or commutate current from the first conduction path to the second conduction path in a second mode of operation;

the second conduction path including at least one second semiconductor switching element to selectively allow current to flow between the first and second terminals through the second conduction path or commutate current from the second conduction path to the third conduction path in the second mode of operation;

the third conduction path including a snubber circuit having an energy storage device to control a rate of change of voltage across the mechanical switching element and oppose current flowing between the first and second terminals in the second mode of operation;

the fourth conduction path including a resistive element to absorb and dissipate energy in the second mode of operation and divert charging current from the first and second terminals away from the energy storage device to limit a maximum voltage across the first and second terminals.

In use, the circuit breaker apparatus may be connected in series with a DC network, and may be further connected in series with a conventional AC circuit breaker or disconnector. Connecting the circuit breaker apparatus to the DC network causes current to flow through the first conduction path of the or each module during normal power transmission in the DC network.

The mechanical switching element partnered with a series-connected low voltage drop semiconductor device in the first conduction path provides a very low conduction voltage drop at low cost and complexity, and is thereby suitable to carry the current from the DC network at all times when breaking or current limiting functions are not required. This not only provides a cost-efficient configuration that significantly decreases the power loss of the circuit breaker apparatus, but also reduces plant cooling requirements and operating costs of the circuit breaker apparatus, thus resulting in an economical equipment design.

The mechanical switching element must be rated to match the available rating of the or each semiconductor switching element in the module. The sub-division of the overall DC network voltage rating into individual voltage ratings for a plurality of series-connected modules, which may number in the hundreds, allows the use of freely available medium-voltage mechanical switching elements and semiconductor devices. Furthermore, the mechanical switching element requires only a short travel distance of its contact elements, which allows fast operation that is required for reliable current interruption but with a low actuation force. This therefore results in a practical and cost-efficient circuit breaker apparatus that is more economical in terms of cost, size and weight than that presented in EP 0 867 998 B1.

In the event of a fault occurring in the DC network resulting in high fault current, the or each first semiconductor switching element is turned off whilst the or each second semiconductor switching element is turned on to commutate the current from the first conduction path to the second conduction path. The mechanical switching element is then opened to isolate the or each first semiconductor switching element, followed by the switching of the or each second semiconductor switching element to commutate the current from the second conduction path to the third conduction path.

Opening of the mechanical switching element alters its voltage withstand capability, which increases with separation in gap between contact elements of the mechanical switching element until the final contact separation distance is reached. Flow of current in the third conduction path charges the energy storage device, e.g. a capacitor, of the snubber circuit, which restricts the rate of rise of voltage applied across the mechanical switching element to a lower value than the rate of rise of withstand capability of the mechanical switching element. This allows the voltage applied across the mechanical switching element to be kept at a lower value than the voltage withstand capability of the mechanical switching element as the contacts are moving.

In the absence of the snubber circuit from the or each module, the mechanical switching element would require its contact elements to be fully separated before the or each second semiconductor switching element may be turned off to commutate the current from the second conduction path to the third conduction path. This would detrimentally decrease the speed of operation of the circuit breaker apparatus. Turning off the or each second semiconductor switching element, before the contact elements of the mechanical switching element have fully parted, could prevent a successful interruption of current and damage the mechanical switching element.

The snubber circuit also removes any voltage surges occurring from circuit inductance when the or each semiconductor switching element in the or each module is turned off which could otherwise damage the or each semiconductor switching element.

The inclusion of the snubber circuit in the or each module therefore improves the speed of operation and reliability of the circuit breaker apparatus.

Charging the energy storage device also results in the formation of an opposing voltage to the voltage on the DC network that forms across the module or the plurality of series-connected modules when coordinated together, and is capable of driving the DC network current to a defined value. At the same time, the resistive element of the fourth conduction path fixes the voltage applied across the or each module to within safe levels, even when current from the DC network is still present between the first and second terminals, by diverting the current away from the snubber circuit and through the resistive element. The circuit breaker apparatus must therefore be designed to contain enough modules connected in series to have a sufficient collective voltage margin to not only absorb and dissipate the voltage surge produced by inductive energy stored in the DC network, but also cope with the nominal voltage rating of the DC network in order to drive the current to zero.

If the current is driven to zero, the apparatus behaves as a circuit breaker. A second conventional AC circuit breaker or disconnector connected in series with the apparatus may then be switched to an open state to complete the current breaking process by providing isolation for safety purposes. Otherwise, if the opposing voltage drives the current to a non-zero value, the apparatus behaves as a current limiter. In this case, the conventional AC circuit breaker may either remain closed or may be omitted in the first place.

After the fault in the DC network has been cleared, the circuit breaker apparatus may revert to its normal operating mode by closing the mechanical switching element and turning on the or each first semiconductor switching element. The resistive element discharges the energy storage device to its steady-state voltage level to allow the mechanical switching element to be safely reclosed. Otherwise, if the energy storage device is still charged to a level substantially above its steady-state voltage level, the ability of the apparatus to perform a subsequent current breaking procedure may be impaired. This is because a high rate of rise of voltage would be applied across the mechanical switching element during the subsequent current breaking procedure, since the voltage across the mechanical switching element increases approximately step-wise to the voltage across the energy storage device.

The configuration of the or each module in the circuit breaker apparatus therefore results in the or each module forming a self-contained unit that can selectively apply a voltage drop into the DC network. The use of a plurality of series-connected modules allows the circuit breaker apparatus to either break or limit current in a DC network. The number of modules provided can be varied to suit low-, medium- and high-voltage electrical applications but is usually rated such that use of all modules drives the current to zero in a given application.

In order to limit current in the DC network, the circuit breaker apparatus may be operated such that only some of the modules provide an opposing voltage to drive the current to a non-zero value, while the remaining modules are left in a bypass mode and thereby do not provide an opposing voltage.

The current-limiting operation may be achieved through use of an embodiment of the circuit breaker apparatus, in which the circuit breaker apparatus includes a plurality of series-connected modules, wherein, in use, the or each second semiconductor switching element of one or more modules may switch to commutate current from the second conduction path to the third conduction path in the second mode of operation whilst the or each second semiconductor switching element of the or each other module may switch to allow current to flow between the first and second terminals through the second conduction path. The modular arrangement of the circuit breaker apparatus permits duty-cycling of the modules collectively in sequenced patterns of second, third and fourth conduction paths during the current limiting mode to make full use of the available rating of the apparatus. This also allows the opposing voltage to be adjusted to drive the current smoothly to any non-zero value that is less than the original fault current level.

Preferably the or each second semiconductor switching element selectively allows current to flow between the first and second terminals through the second conduction path in the first mode of operation.

The circuit breaker apparatus may be required to revert to its normal operating mode within a predetermined period of time after breaking or limiting current. As described earlier, if the energy storage device is still charged above its steady-state voltage level during re-closing of the mechanical switching element, the ability of the apparatus to perform a subsequent current breaking procedure may be impaired. The or each second semiconductor switching element may be operated to momentarily allow current to flow between the first and second terminals through the second conduction path. If the fault has not yet been cleared, the or each second semiconductor switching element is turned off to stop the flow of current through the circuit breaker apparatus.

In the event that the fault has been cleared but the energy storage device is still charged above its steady-state voltage level, the or each second semiconductor switching element may be momentarily switched to allow the second conduction path to conduct current during normal operation of the DC network until the voltage across the energy storage device has decayed to its steady-state voltage level. During this period, although power losses are higher than normal, such power losses are still acceptable because of the relatively brief period of exposure to the higher losses. At this time the mechanical switching element and the or each first semiconductor switching element are closed to allow current to flow between the first and second terminals through the first conduction path before the or each second semiconductor switching element is turned off to resume normal operation.

In embodiments of the invention, the mechanical switching element may include retractably engaged contact elements located within a dielectric medium. Such a mechanical switching element may, for example, be a vacuum interrupter.

The commutation of current from the first conduction path to the second conduction path in the second mode of operation minimises the amount of current in the first conduction path during the opening of the mechanical switching element, which results in little to no arcing and thereby increases the lifetime of the mechanical switching element.

The choice of dielectric medium affects the voltage withstand capability of the mechanical switching element. The dielectric medium may be a high-performance dielectric medium, which may be, but not limited to, oil, vacuum or sulphur hexafluoride. Use of high-performance dielectric media enables a small separation between the contact elements of the mechanical switching element to result in a high isolation voltage. This in turn facilitates rapid switching of the mechanical switching element, since the contact elements are only required to travel a short distance to achieve the required separation. A short separation between the contact elements also reduces the actuation energy required to operate the mechanical switching element, thus reducing the size, cost and weight of the circuit breaker apparatus.

In further embodiments of the invention, the or each first semiconductor switching element may be or may include a field-effect transistor or insulated gate bipolar transistor. The or each first semiconductor switching element may be connected in parallel with an anti-parallel diode.

In still further embodiments, the or each second semiconductor switching element may be or may include an insulated gate bipolar transistor, a gate turn-off thyristor, a gate-commutated thyristor, an integrated gate-commutated thyristor or a MOS-controlled thyristor. The or each second semiconductor switching element may be connected in parallel with an anti-parallel diode.

The or each semiconductor switching element may be made from, but not limited to, silicon or a wide-band-gap semiconductor material such as silicon carbide, diamond or gallium nitride.

The required current rating of the or each semiconductor switching element may vary depending on whether the or each module is used to break or limit the current. This is because each semiconductor switching element is only required to be momentarily switched into circuit once during the circuit breaking event with a duration in the order of milliseconds. However, when the corresponding module is used to limit current, the or each semiconductor switching element is then required to be continuously switched into circuit, or required to switch the corresponding module in and out of bypass on a duty cycle for tens or hundreds of milliseconds, thus requiring a higher and continuous power rating of the or each semiconductor switching element.

It will be appreciated that the on-state voltage drop across the or each first semiconductor switching element is preferably set to be as low as possible so as to minimise conduction losses resulting from the flow of current through the first conduction path during power transmission in the DC network. In addition, the off-state voltage withstand capability of the or each second semiconductor switching element is preferably several orders of magnitude higher than the on-state voltage drop across the or each first semiconductor switching element to improve the efficiency of the circuit breaker apparatus. This is because the relative power loss of the circuit breaker apparatus is directly proportional to the ratio of the on-state voltage across the first semiconductor switching element(s) to the off-state voltage of the second semiconductor switching element(s).

The resistive element may include at least one linear resistor and/or at least one non-linear resistor, e.g. a metal-oxide varistor.

Preferably the fourth conduction path further includes an auxiliary switching element connected to the resistive element, the auxiliary switching element being operable to modify flow of current through or voltage drop across the resistive element. The auxiliary switching element may be, for example, a solid-state switch such as a thyristor or an IGBT, or a mechanical switch such as a vacuum interrupter or a high-voltage relay.

The use of the auxiliary switching element allows the resistive element to be selectively switched into or out of circuit to modify the flow of current through or the voltage drop across the resistive element so as to control the absorption and dissipation of energy by the resistive element. When the resistive element consists of a plurality of resistive element parts, the auxiliary switching element and the plurality of resistive element parts may be arranged so that the auxiliary switching element is able to switch some of the resistive element parts, instead of the entire resistive element, out of circuit when modifying the flow of current through or the voltage drop across the resistive element, whilst the other resistive element parts remain in circuit.

This feature may be used to prevent the energy storage device from being fully discharged to zero volts and thereby maintain a minimum voltage level of the energy storage device, which may be used as a power source for a local power supply for the module to power the or each second semiconductor switching element and the mechanical switching element.

The local power supply may include a DC-to-DC converter connected across the energy storage device to harvest power. However, since current flows through the first conduction path and not through the third conduction path during power transfer in the DC network, there is no regular charging of the energy storage device, which may lead to discharging of the energy storage device to zero volts. This in turn prevents the DC-to-DC converter from harvesting power for use as a power source for a local power supply.

In circumstances where the energy storage device has fully discharged after a current breaking or limiting procedure, the energy storage device may be required to charge to a minimum threshold voltage to enable the local power supply to power the one or more components of the circuit breaker apparatus. Re-connection of the energy storage device to a current-carrying DC network may cause rapid charging, and rise in voltage, of the energy storage device. After the energy storage device has been charged up to the required voltage level, the or each second semiconductor switching element may then be turned on to arrest any further rise of voltage before the mechanical switching element and the or each first semiconductor switching element are turned on.

In embodiments of the invention, the circuit breaker apparatus may further include a local power supply to power one or more components of the circuit breaker, the local power supply being connected to the energy storage device, wherein the or each first semiconductor switching element selectively commutates current from the first conduction path to the third conduction path to control a voltage of the energy storage device in the first mode of operation.

During normal operation of the DC network, the or each first semiconductor switching element may be turned off periodically for a short period of time, e.g. tens of microseconds, to commutate the current into the third conduction path and charge the energy storage device. The or each first semiconductor switching element is then turned on to commutate the current from the third conduction path into the first conduction path to stop charging the energy storage device. A hysteresis control strategy may therefore be employed, whereby the voltage of the energy storage device is maintained between predetermined minimum and maximum values through switching of the or each first semiconductor switching element. The power losses experienced by the DC network during the use of the hysteresis control strategy are negligible.

In other embodiments of the invention, the circuit breaker apparatus may further include a local power supply to power one or more components of the circuit breaker, and a depletion-mode field-effect transistor to connect the energy storage device to the local power supply.

The depletion-mode field-effect transistor may, for example, be a MOSFET or JFET, and/or made from a wide band-gap semiconductor material.

If the circuit breaker apparatus is exposed to a period with low or no DC network transmission current, it may lead to the energy storage device being fully discharged. At re-energisation, the depletion-mode field-effect transistor is initially in an on-state to allow the local power supply to immediately start up as soon as a voltage appears across the DC storage device. During a fault scenario where the voltage of the energy storage device transiently rises to many times its steady-state voltage level, the depletion-mode field-effect transistor is turned off or enters its current-limiting mode to prevent the local power supply from being damaged by the high voltage.

The configuration of the or each module may vary depending on the requirements of the circuit breaker apparatus.

In embodiments of the invention, the first, second and third conduction paths may be connected in parallel between the first and second terminals.

In embodiments of the circuit breaker apparatus employing the use of a plurality of series-connected modules, one or more modules may be connected in reverse direction to one or more other modules, so as to control and/or break current in both directions.

In other embodiments of the invention, the first conduction path may include a mechanical switching element connected in series with two first semiconductor switching elements; the second conduction path may include two second semiconductor switching elements; and the snubber circuit may include an energy storage device and two diodes, each second semiconductor switching element being connected in series with a respective one of the diodes of the snubber circuit to define a set of current flow control elements, the sets of current flow control elements being connected in parallel with the capacitor in a full-bridge arrangement.

The use of one or more modules configured in this manner results in a circuit breaker apparatus with bidirectional current breaking and limiting capabilities.

Preferably the fourth conduction path may be connected in parallel with the energy storage device of the snubber circuit, or connected in parallel with the first, second and/or third conduction paths.

Preferred embodiments of the invention will now be described, by way of non-limiting examples, with reference to the accompanying drawings in which:

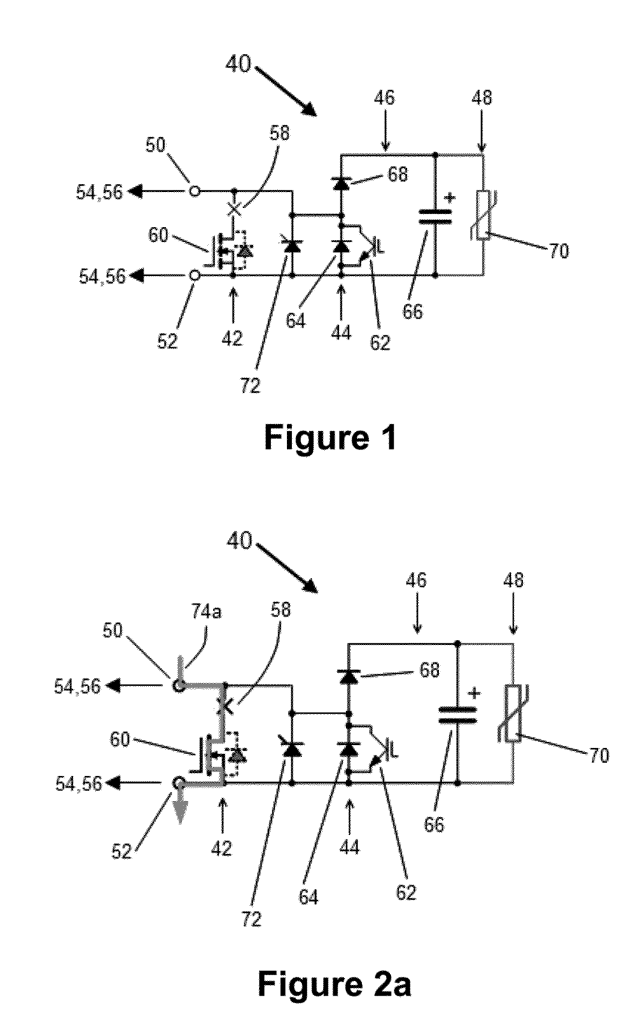

FIG. 1 shows, in schematic form, a module forming part of a circuit breaker apparatus according to a first embodiment of the invention;

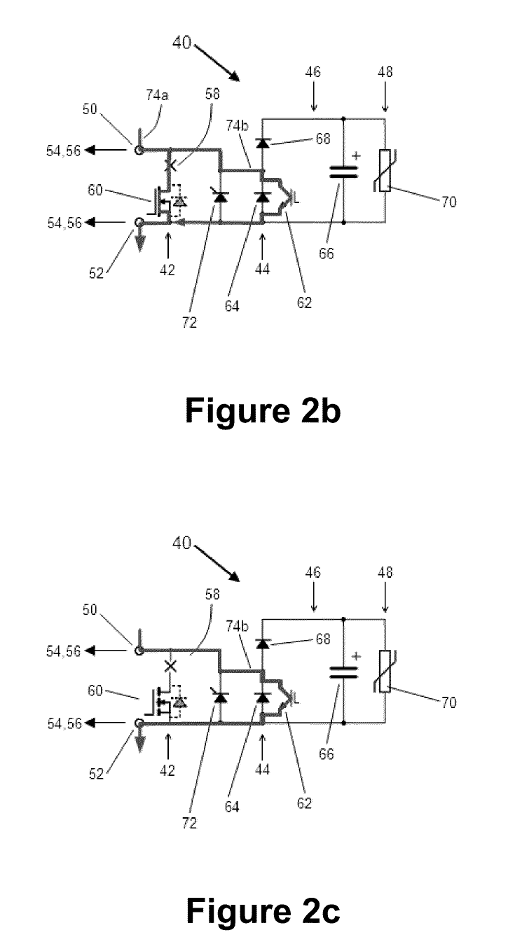

FIGS. 2a to 2f illustrate the operation of the module of FIG. 1 to break or limit current;

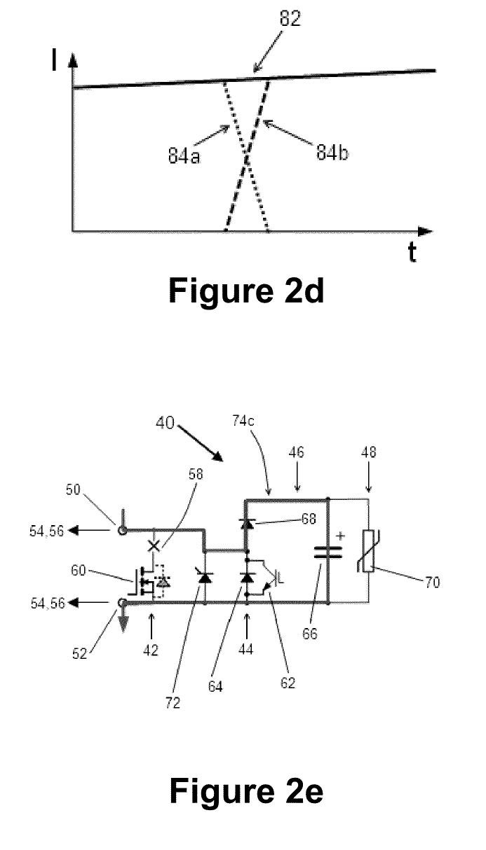

FIG. 3 illustrates the changes in voltage and current in the conduction paths of the module of FIG. 1;

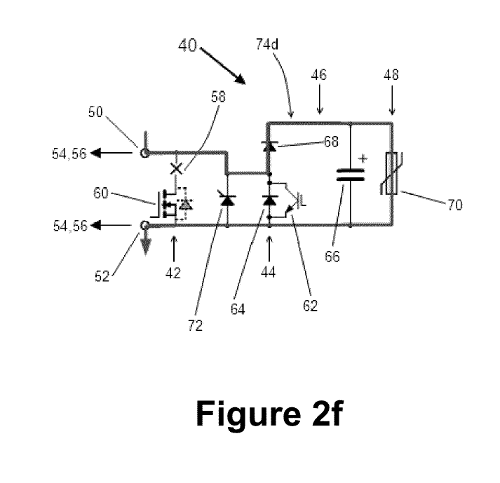

FIG. 4 shows, in schematic form, a module forming part of a circuit breaker apparatus according to a second embodiment of the invention;

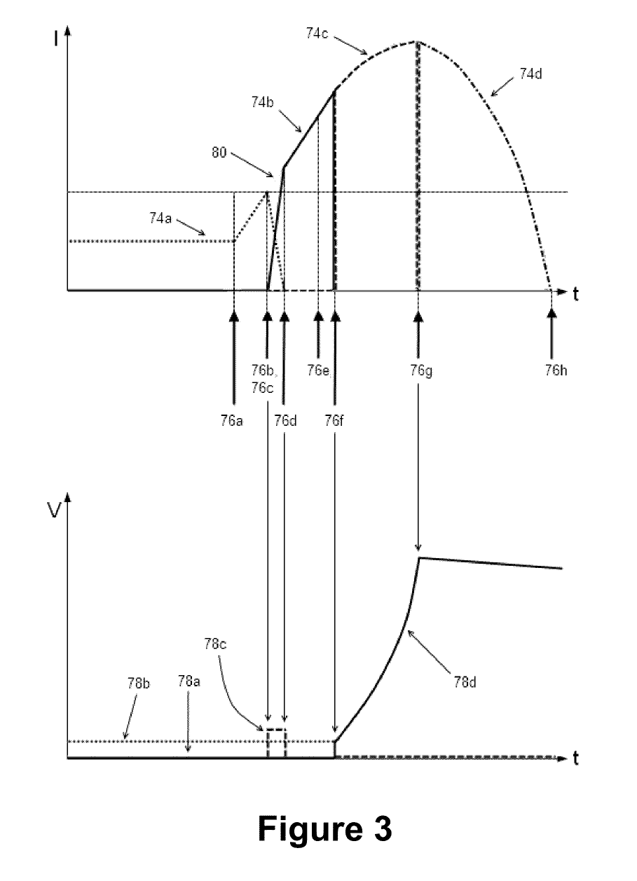

FIG. 5 shows, in schematic form, a module forming part of a circuit breaker apparatus according to a third embodiment of the invention;

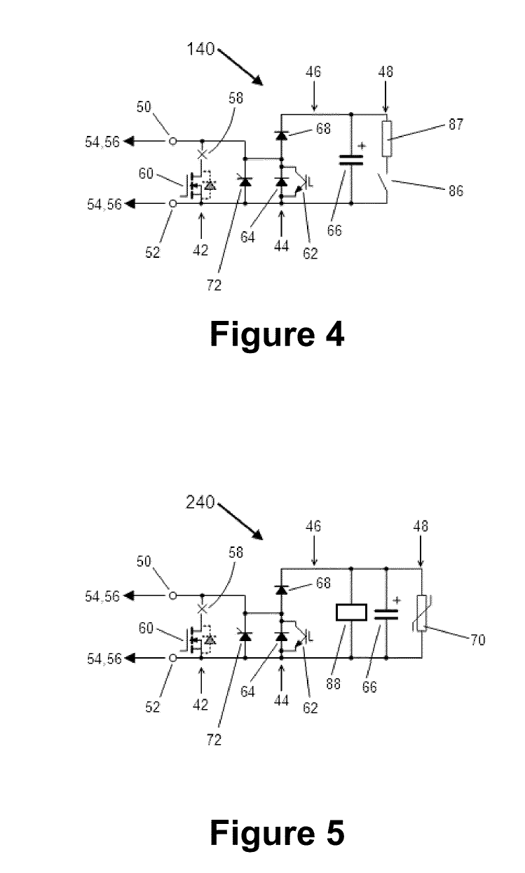

FIG. 6 illustrates the hysteresis voltage control for the capacitor using the FET of the module in FIG. 5;

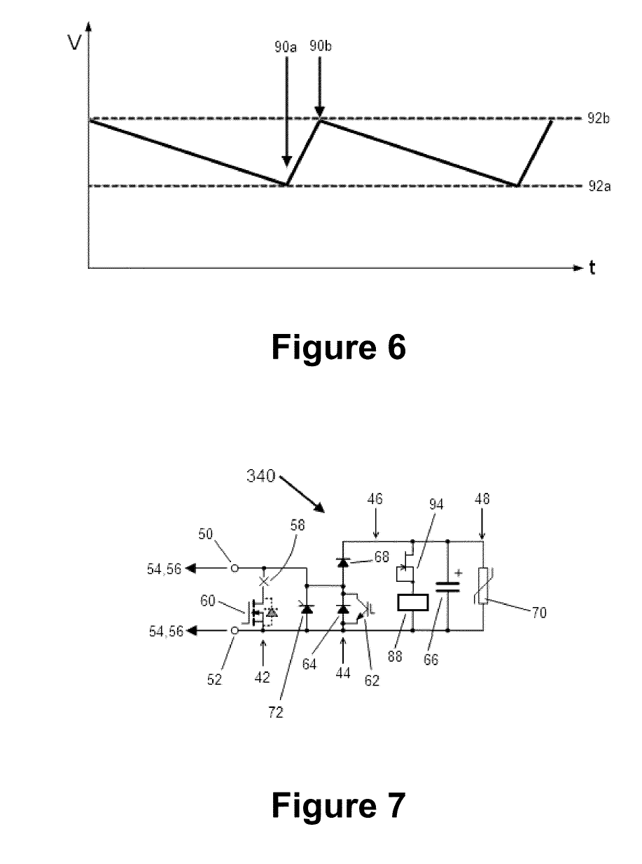

FIG. 7 shows, in schematic form, a module forming part of a circuit breaker apparatus according to a fourth embodiment of the invention; and

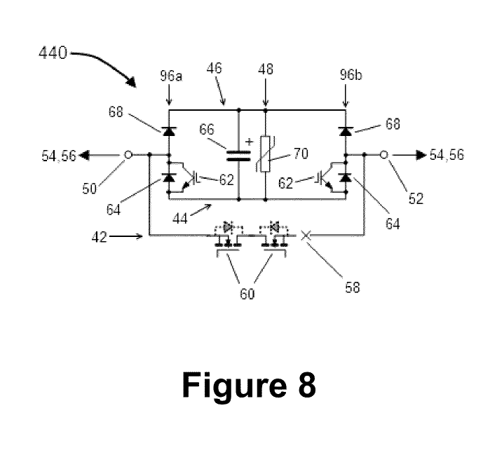

FIG. 8 shows, in schematic form, a module forming part of a circuit breaker apparatus according to a fifth embodiment of the invention.

A module 40 forming part of a circuit breaker apparatus according to a first embodiment of the invention is shown in FIG. 1.

The first circuit breaker apparatus comprises a plurality of series-connected modules 40. Each module 40 includes: first, second, third and fourth conduction paths 42,44,46,48; and first and second terminals 50,52.

In use, the first and second terminals 50,52 of each module 40 are connected in series with a DC network 54 and an AC circuit breaker 56.

The first conduction path 42 includes a mechanical switching element connected in series with a first semiconductor switching element. The mechanical switching element is a vacuum interrupter 58 with retractably engaged contact elements located inside a vacuum, while the first semiconductor switching element is a field-effect transistor (FET) 60.

It is envisaged that, in other embodiments of the invention (not shown), the FET may be replaced by a plurality of FETs, e.g. a plurality of parallel-connected FETs to obtain a low on-resistance. For example, FETs rated at 24V are commercially available with an on-resistance R of less than 1 mΩ per chip, which means that the use of 20 such chips in parallel would result in an on-resistance of 50 μΩ, and hence an on-state voltage of 0.1 V at a current of 2000 A.

The second conduction path 44 includes a second semiconductor switching element in the form of an insulated gate bipolar transistor (IGBT) 62, which is connected in parallel with an anti-parallel diode 64.

As described earlier, the off-state voltage withstand capability of the IGBT 62 is preferably several orders of magnitude higher than the on-state voltage of the FET 60 to improve the efficiency of the first circuit breaker apparatus.

The third conduction path 46 includes a snubber circuit, which includes a capacitor 66 and a diode 68 arranged to define a capacitor-diode turn-off snubber arrangement.

The first, second and third conduction paths 42,44,46 are connected in parallel between the first and second terminals 50,52.

The fourth conduction path 48 includes a resistive element in the form of a metal-oxide varistor 70, which is connected in parallel with the capacitor 66 of the snubber circuit. The metal-oxide varistor 70 is a non-linear resistor, which has a high resistance at low voltages and a low resistance at high voltages.

In other embodiments of the invention (not shown), it is envisaged that the metal-oxide varistor may be replaced by a plurality of metal-oxide varistors, at least one other non-linear resistor, at least one linear resistor, or a combination thereof.

Each module 40 further includes a thyristor 72 connected in parallel with the IGBT 62. The thyristor 72 may be turned on during transient fault currents in the reverse direction to protect the anti-parallel diode 64. This allows the first circuit breaker apparatus to be connected, in use, to a DC network having a mesh structure with load and fault currents of different polarities.

In other embodiments, it is envisaged that, if the current is required to be controlled or broken in both directions, one or more additional modules may be connected in series with and in reverse direction to the existing plurality of modules to control and/or break the current flow in the opposite direction.

It is envisaged that, in other embodiments (not shown), the thyristor 72 may be omitted from each module 40. In these embodiments, the diode 64 may be protected from over-current by closing the mechanical switching element 58 to commutate the transient fault current from the second conduction path 44 to the first conduction path 42.

Operation of each module 40 of the first circuit breaker apparatus in FIG. 1 to break current in the DC network 54 is described as follows, with reference to FIGS. 2a to 2f and FIG. 3.

FIG. 3 illustrates the changes in current and voltage in the conduction paths 42,44,46,48 in the module 40 of FIG. 1 during the current breaking procedure.

During normal operating conditions of the DC network 54, the vacuum interrupter 58 and the FET 60 are closed to allow current 74a to flow through the DC network 54, the AC circuit breaker 56 and the first conduction path 42 of the module 40, as shown in FIG. 2a. At this stage the current 74a does not flow through the second, third and fourth conduction paths 44,46,48; there is no voltage drop 78a across the vacuum interrupter 58 and the IGBT 62, and the capacitor 66 is charged to a non-zero steady-state voltage level 78b.

A fault or other abnormal operating condition in the DC network 54 may lead to high fault current flowing through the DC network 54.

In response to an event 76a of high fault current in the DC network 54, the FET 60 is switched to an wholly or partially off-state 76b whilst the IGBT 62 is switched to an on-state 76c. The switching 76b of the FET 60 to an off-state creates a back electromotive force 78c that is sufficiently large to commutate the current 74a from the first conduction path 42 to the second conduction path 44. This causes current 74b to flow through the second conduction path 44, as shown in FIG. 2b. The current commutation process 80 continues until full commutation of the current 74a from the first conduction path 42 to the second conduction path 44 is complete, as shown in FIG. 2c.

The rate, di/dt, at which the current 74a commutates from the first conduction path 42 to the second conduction path 44 is calculated as follows:

$$\frac{d i}{d t} = \frac{{V}_{FET} - {V}_{IGBT}}{{L}_{stray}}$$

Where V_{FET} is the off-state voltage across the FET 60;
V_{IGBT} is the on-state voltage of the IGBT 62; and
L_{stray} is the stray inductance of the conductor loop formed by the vacuum interrupter 58, FET 60 and IGBT 62.

For example, if V_{FET} is 53 V, V_{IGBT} is 3 V and L_{stray} is 50 nH, the rate at which the current 74a commutates from the first conduction path 42 to the second conduction path 44 is 1000 A per microsecond.

FIG. 2d illustrates the changes in current flowing through the first and second conduction paths 42,44 with time. It is shown that the rate 82 of rise of current in the DC network 54 is much lower than the rate of commutation of current 74a from the first conduction path 42 to the second conduction path 44, which is given by the rates of change of current 84a, 84b in the first and second conduction paths 42,44.

Once the full commutation of the current 74a from the first conduction path 42 to the second conduction path 44 is complete, a trip coil of the vacuum interrupter 58 is then activated 76d to initialize separation 76e of the vacuum interrupter's contact elements. The high rate of commutation of current 74a from the first conduction path 42 to the second conduction path 44 results in little to zero current in the first conduction path 42 by the time the contact elements begin to separate 76e. As such, there is little to no arcing between the separated contact elements. The opening 76e of the contact elements of the vacuum interrupter 58 isolates, and thereby protects, the FET 60 from high voltages appearing across the first and second terminals 50,52.

The IGBT 62 is then turned off 76f to commutate the current 74b flowing in the second conduction path 44 into the third conduction path 46, as shown in FIG. 2e. This causes current 74c to flow in the third conduction path 46 and into the capacitor 66, which charges at a rate given as follows:

$$\frac{d {V}_{C}}{d t} = \frac{{I}_{C}}{C}$$

Where dV_{C}/dt is the rate of change of voltage across the capacitor 66;
I_{C} is the current 74c flowing through the third conduction path 46; and
C is the capacitance of the capacitor 66.

Charging of the capacitor 66 results in an increase in voltage 78d across the capacitor 66, which is applied across the vacuum interrupter 58 and the IGBT 62, as shown in FIG. 3. In order to protect the vacuum interrupter 58, the voltage 78d applied across the vacuum interrupter 58 is kept lower than the voltage withstand capability of the vacuum interrupter 58, which increases to its rated value with increasing separation in the gap between its contact elements until the final contact separation distance is reached. This is achieved by setting the capacitance value of the capacitor 66 to control the rate of rise of voltage across the capacitor 66 to be lower than the rate of rise of voltage withstand capability of the vacuum interrupter 58. A typical time period for the rise of voltage withstand capability for separating contact elements in the vacuum interrupter 58 to attain a final voltage withstand value is 1 to 2 milliseconds.

The voltage 78d across the capacitor 66 produces a back electromotive force that opposes the fault current flowing through the DC network 54, the AC circuit breaker 56 and each module 40. The metal-oxide varistor 70 is activated 76g, if and when the capacitor voltage reaches the safe limit for the vacuum interrupter 58 and IGBT 62 to divert any extra charging current 74d through the fourth conduction path 48, as shown in FIG. 2f. The metal-oxide varistor 70 thus absorbs and dissipates energy from the DC network 54 whilst the back electromotive force is building up to control the DC network current.

The back electromotive force eventually becomes sufficiently large across all the series-connected modules 40 to absorb the inductive energy from the DC network and drive the current to zero within a reasonable amount of time. After the current reaches zero 76h, the series-connected AC circuit breaker 56 is opened to complete the current breaking procedure and isolate the fault in the DC network 54.

If the circuit breaker apparatus is required to be re-closed shortly after the current breaking procedure has been completed, the AC circuit breaker 56 is closed, followed by the IGBTs 62 in all the series-connected modules 40 being turned on to allow current to flow through the second conduction path 44. However, if the fault is still present in the DC network 54, the IGBTs 62 may be rapidly turned off in all of the series-connected modules 40 to halt current flow through the circuit breaker apparatus. On the other hand, if the fault in the DC network 54 has been cleared, the circuit breaker apparatus may then revert to its normal operating mode by turning on the FETs 60 and closing the vacuum interrupters 58 in all of the modules 40, before turning off the IGBTs 62 to resume normal operation of the DC network 54.

In circumstances where the fault has been cleared but the capacitor 66 is still charged to a level substantially above its steady-state voltage level 78b, the AC circuit breaker 56 is closed, followed by the IGBTs 62 being turned on in all of the of series-connected modules 40 to allow current to flow through the second conduction path 44. Meanwhile the metal-oxide varistor 70 discharges the capacitor 66 to its steady-state voltage level 78b. This minimises the risk of the voltage across the capacitor 66 impairing the ability of the vacuum interrupter 58 to undergo a subsequent current breaking procedure. After the capacitor 66 has reverted to its steady-state voltage level 78b, the FETs 60 is turned on and the vacuum interrupters 58 in all of the modules 40 is closed before the IGBTs 62 is turned off in all the modules 40 to resume normal operation of the DC network 54.

To operate the first circuit breaker apparatus in a current-limiting mode, some of the series-connected modules 40 are operated so that their capacitors 66 produce a back electromotive force to oppose part of the current flowing through the DC network 54 and thereby drive the current to a lower non-zero value or prevent a further rise of current. Meanwhile the remaining modules 40 are operated so that their IGBTs 62 remain turned on to allow current to continue flowing between the first and second terminals 50,52 through the corresponding second conduction paths 44, and so their capacitors 66 do not contribute any back electromotive force to drive the current to the lower non-zero value.

The modular arrangement of the first circuit breaker apparatus permits duty-cycling of the modules 40 to make full use of the available rating of the first circuit breaker apparatus. This also allows the generated back electromotive force to be smoothly varied from zero voltage to the required voltage.

Optionally the first circuit breaker apparatus may be initially operated in the current-limiting mode before switching to the current-breaking mode. This may be useful in circumstances where the first circuit breaker apparatus is required to temporarily take over current-breaking duties from another circuit breaker, which has failed to perform a current-breaking procedure.

The first circuit breaker apparatus is therefore capable of breaking and/or limiting current in the DC network.

A module 140 forming part of a circuit breaker apparatus according to a second embodiment of the invention is shown in FIG. 4. The second circuit breaker apparatus includes a plurality of series-connected modules 140. Each module 140 of the second embodiment of the circuit breaker apparatus in FIG. 4 is similar in terms of structure and operation to each module 40 of the first embodiment of the circuit breaker apparatus in FIG. 1, and like features share the same reference numerals.

Each module 140 of the second circuit breaker apparatus differs from each module 40 of the first circuit breaker apparatus in that, in each module 140 of the second circuit breaker apparatus, the fourth conduction path 48 further includes an auxiliary switching element 86 connected in series with a linear resistor 87.

The auxiliary switching element 86 may be, for example, a solid-state switch such as a thyristor or an IGBT, or a mechanical switch such as a vacuum interrupter or a high-voltage relay.

It is envisaged that, in other embodiments of the invention, the linear resistor 87 may be replaced by a plurality of linear resistors, at least one other linear resistor, at least one non-linear resistor, e.g. a metal-oxide varistor, or a combination thereof. It is further envisaged that, in embodiments employing the use of a plurality of resistors, the auxiliary switching element 86 may be configured to selectively switch either some or all of the plurality of resistors into and out of circuit.

The provision of the auxiliary switching element 86 in each module 140 of the second circuit breaker apparatus allows the linear resistor 87 to be selectively switched into or out of circuit to control the absorption and dissipation of energy by the linear resistor 87. This feature may be used to prevent the capacitor 66 from being fully discharged to zero volts and thereby maintain a minimum voltage level of the capacitor 66. This in turn allows the capacitor 66 to be used as a power source for a local power supply to provide power to the circuit of the vacuum interrupter 58, FET 60 and IGBT 62.

A module 240 forming part of a circuit breaker apparatus according to a third embodiment of the invention is shown in FIG. 5. The third circuit breaker apparatus includes a plurality of series-connected modules 240. Each module 240 of the third embodiment of the circuit breaker apparatus in FIG. 5 is similar in terms of structure and operation to each module 40 of the first embodiment of the circuit breaker apparatus in FIG. 1, and like features share the same reference numerals.

Each module 240 of the third circuit breaker apparatus differs from each module 40 of the first circuit breaker apparatus in that each module 240 of the third circuit breaker apparatus further includes a local power supply 88, which includes a DC-to-DC converter connected in parallel with the capacitor 66 to harvest power from the capacitor 66 and supply power to the circuit of the vacuum interrupter 58, FET 60 and IGBT 62.

It is envisaged that, in other embodiments (not shown), the local power supply may be used to supply power to local control and monitoring units associated with the circuit breaker apparatus.

As described above, after the fault in the DC network 54 has been cleared, the metal-oxide varistor 70 discharges the capacitor 66 to its steady-state voltage level. In circumstances where the steady-state voltage level is insufficient to enable use of the local power supply 88, a hysteresis control strategy is employed to maintain a minimum voltage level of the capacitor 66. The hysteresis control is achieved by periodically turning the FET 60 off and on 90a,90b, to maintain the voltage of the capacitor 66 between predetermined minimum and maximum voltages 92a,92b, as shown in FIG. 6.

When the capacitor 66 has been discharged to the predetermined minimum voltage 92a, the FET 60 is turned off 90a for a short period of time, e.g. tens of microseconds, to commutate the current from the first conduction path 42 to the third conduction path 46 and thereby charge the capacitor 66. After the capacitor 66 has been charged to the predetermined maximum voltage 92b, the FET 60 is turned on 90b to commutate the current back into the first conduction path 42 to resume normal operation.

It will be appreciated that the voltage of the capacitor 66 may be maintained at a relatively low level, e.g. in the range of tens of volts, during normal operation of the DC network 54 to accommodate the following requirements, which are:
a sufficiently high voltage for the local power supply to function;
a low voltage rating of the FET 60 to minimise its on-resistance and its ensuing power losses during normal operation of the DC network 54;
a maximum voltage of the capacitor 66 that is as low as possible to prevent damage to the FET 60 when the voltage of the capacitor 66 appears across the FET 60 during turn-off

In the event that the voltage required for the local power supply is higher than the voltage rating of the FET 60 and maximum voltage of the capacitor 66, each module 240 of the third circuit breaker apparatus may include a step-up DC-to-DC converter to step up the voltage of the capacitor 66 in order to provide the local supply with the required higher voltage.

A module 340 forming part of a circuit breaker apparatus according to a fourth embodiment of the invention is shown in FIG. 7. The fourth circuit breaker apparatus includes a plurality of series-connected modules 340. Each module 340 of the fourth embodiment of the circuit breaker apparatus in FIG. 7 is similar in terms of structure and operation to each module 240 of the third embodiment of the circuit breaker apparatus in FIG. 5, and like features share the same reference numerals.

Each module 340 of the fourth circuit breaker apparatus differs from each module 240 of the third circuit breaker apparatus in that, in each module 340 of the fourth circuit breaker apparatus 340, the local power supply 88 is connected in series with a depletion-mode FET 94, and the series connection of the local power supply 88 and the depletion-mode FET 94 is connected in parallel with the capacitor 66.

During operation of each module 340 of the fourth circuit breaker apparatus, the depletion-mode FET 94 is kept in constant current connection. After the current breaking or limiting procedure has been completed, the metal-oxide varistor 70 may discharge the capacitor 66 to a voltage that is insufficient to enable use of the local power supply 88. At this time the depletion-mode FET 94 is in its on-state to allow immediate start-up of the local power supply 88 as soon as a sufficiently large voltage appears across the capacitor 66, and remains in its on-state during normal operation of the DC network 54.

In the event of a fault occurring in the DC network 54 that causes the voltage of the capacitor 66 to transiently rise to many times its steady-state voltage level, the depletion-mode FET 94 is turned off or enters a current-limiting mode to limit the current flowing into the local power supply and thereby protect the local power supply 88 from being damaged by the high voltage of the capacitor 66.

The use of the depletion-mode FET 94 therefore allows the local power supply 88 to safely harvest power from the capacitor 66 during normal operation of the DC network 54, without compromising the ability of the capacitor 66 to provide a high back electromotive force to drive a fault current to a lower value.

A module 440 forming part of a circuit breaker apparatus according to a fifth embodiment of the invention is shown in FIG. 8. The fifth circuit breaker apparatus includes a plurality of series-connected modules 440. Each module 440 of the fifth embodiment of the circuit breaker apparatus in FIG. 8 is similar in terms of structure and operation to each module 40 of the first embodiment of the circuit breaker apparatus in FIG. 1, and like features share the same reference numerals.

Each module 440 of the fifth circuit breaker apparatus differs from each module 40 of the first circuit breaker apparatus in that, in each module 440 of the fifth circuit breaker apparatus:
the first conduction path 42 includes a vacuum interrupter 58 connected in series with two FETs 60, which are connected back to back;
the second conduction path 44 includes two IGBTs 62, which are also connected back to back;
the snubber circuit of the third conduction path 46 includes a capacitor 66 and two diodes 68. Each IGBT 62 of the second conduction path 44 is connected in series with a respective one of the diodes 68 of the snubber circuit to define a set of current flow control elements 96a,96b. The sets of current flow control elements 96a,96b are connected in parallel with the capacitor 66 in a full-bridge arrangement.

The configuration of each module 440 in this manner results in a circuit breaker apparatus 440 with bi-directional current-breaking and/or current-limiting capabilities.

It is envisaged that, in other embodiments of the invention, the circuit breaker apparatus may include a combination of any of the features described with reference to the above embodiments.

1. A circuit breaker apparatus for use in high voltage direct current (HVDC) power transmission, the circuit breaker apparatus comprising at least one module of a plurality of series-connected modules;
the at least one module including: first, second, third and fourth conduction paths; and first and second terminals for connection to an electrical network, each conduction path extending between the first and second terminals;
the first conduction path including a mechanical switching element connected in series with at least one first semiconductor switching element to selectively allow current to flow between the first and second terminals through the first conduction path in a first mode of operation or commutate current from the first conduction path to the second conduction path in a second mode of operation;
the second conduction path including at least one second semiconductor switching element to selectively allow current to flow between the first and second terminals through the second conduction path or commutate current from the second conduction path to the third conduction path in the second mode of operation;
the third conduction path including a snubber circuit having an energy storage device to control a rate of change of voltage across the mechanical switching element and oppose current flowing between the first and second terminals in the second mode of operation;
the fourth conduction path including a resistive element to absorb and dissipate energy in the second mode of operation and divert charging current from the first and second terminals away from the energy storage device to limit a maximum voltage across the first and second terminals.

2. A circuit breaker apparatus according to claim 1 including a plurality of series-connected modules, wherein, in use, the or each second semiconductor switching element of one or more modules switches to commutate current from the second conduction path to the third conduction path in the second mode of operation whilst the or each second semiconductor switching element of the or each other module switches to allow current to flow between the first and second terminals through the second conduction path.

3. A circuit breaker apparatus according to claim 1 wherein the second semiconductor switching element selectively allows current to flow between the first and second terminals through the second conduction path in the first mode of operation.

4. A circuit breaker apparatus according to claim 1 wherein the mechanical switching element includes retractably engaged contact elements located within a dielectric medium.

5. A circuit breaker apparatus according to claim 1 wherein the first semiconductor switching element is or includes a field-effect transistor or insulated gate bipolar transistor.

6. A circuit breaker apparatus according to claim 1 wherein the second semiconductor switching element is or includes an insulated gate bipolar transistor, a gate turn-off thyristor, a gate-commutated thyristor, an integrated gate-commutated thyristor or a MOS-controlled thyristor.

7. A circuit breaker apparatus according to claim 1 wherein the resistive element includes at least one of a linear resistor and at least one non-linear resistor.

8. A circuit breaker apparatus according to claim 1 wherein the fourth conduction path further includes an auxiliary switching element connected to the resistive element, the auxiliary switching element being operable to modify flow of current through or voltage drop across the resistive element.

9. A circuit breaker apparatus according to claim 1 further including a local power supply to power one or more components of the circuit breaker, the local power supply being connected to the energy storage device, wherein the or each first semiconductor switching element selectively commutates current from the first conduction path to the third conduction path to control a voltage of the energy storage device in the first mode of operation.

10. A circuit breaker apparatus according to claim 1 further including a local power supply to power one or more components of the circuit breaker, and a depletion-mode field-effect transistor to connect the energy storage device to the local power supply.

11. A circuit breaker apparatus according to claim 1 wherein the first, second and third conduction paths are connected in parallel between the first and second terminals.

12. A circuit breaker apparatus according to claim 1 including a plurality of series-connected modules, wherein one or more modules is connected in reverse direction to one or more other modules.

13. A circuit breaker apparatus according to claim 1 wherein the first conduction path includes a mechanical switching element connected in series with two first semiconductor switching elements;
the second conduction path includes two second semiconductor switching elements; and
the snubber circuit includes an energy storage device and two diodes, each second semiconductor switching element being connected in series with a respective one of the diodes of the snubber circuit to define a set of current flow control elements, the sets of current flow control elements being connected in parallel with the energy storage device in a full-bridge arrangement.

14. A circuit breaker apparatus according to claim 1 wherein the fourth conduction path is connected in parallel with the energy storage device of the snubber circuit.

15. A circuit breaker apparatus according to claim 1 wherein the fourth conduction path is connected in parallel with the first, second and/or third conduction paths.
